(19) United States
(12) Patent Application Publication
(10) Pub. No.: US 2003/0086534 A1
(43) Pub. Date: May 8, 2003

(54) Radiation diaphragm for an X-ray apparatus

(75) Inventor: Matthias Seufert, Oberreichenbach (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/288,096

(22) Filed: Nov. 5, 2002

(30) Foreign Application Priority Data
Nov. 7, 2001 (DE) 10154539.8

(51) Int. Cl. G21K 1/04

(52) U.S. Cl. 378/150

(57) ABSTRACT

A radiation diaphragm for an X-ray apparatus has an absorber element that is seated so as to be eccentrically rotatable around a rotational axis oriented in its longitudinal direction, so that the size of the ray beam is variable by means of a rotary motion of the absorber element. The absorber element is fashioned, for example, as a drum, a roller or a cylinder. The radiation diaphragm can be implemented especially rugged and is suited for higher rotational speeds in a computed tomography apparatus.

### BACKGROUND OF THE INVENTION

1. Field of the Invention

The present invention is directed to a radiation diaphragm for an X-ray apparatus, of the type having an absorber element that is adjustable in position for variably limiting a ray beam.

2. Description of the Prior Art

German OS 44 37 969 discloses an example of an X-ray apparatus having a radiation diaphragm of the above type. In an X-ray apparatus fashioned as a computer tomography apparatus, an X-ray fan is generated by the primary radiation diaphragm fashioned as a slit diaphragm. This fan determines the dose profile in the patient, and thus the slice thickness in the exposure. It thus also influences the dose stress on the patient and the intensity of the detector signal from which the image data are acquired. For setting various slice thicknesses, it is necessary to set various apertures of the primary radiation diaphragm.

A slit diaphragm can be realized, for example jaws, functioning as absorber elements, into the ray beam or out of this in the fashion of a parallelogram. Slut diaphragms realized in this way are composed of a multitude of moving parts.

Diaphragms having rotatably seated absorber elements are also known, for example from German OS 31 36 971 or German OS 36 00 824. These diaphragms are likewise very complicated.

### SUMMARY OF THE INVENTION

An object of the present invention is to provide a radiation diaphragm for an X-ray apparatus as well as an X-ray apparatus having a radiation diaphragm that allow an especially rugged design.

The above object is achieved in accordance with the principles of the present invention in a radiation diaphragm for an X-ray apparatus having an absorber element that is eccentrically mounted so as to be rotatable around a longitudinal axis, and the absorber element having a shape so that by rotation around the longitudinal axis a larger or a smaller portion of the absorber element is disposed in the path of an X-ray beam.

The invention is based on the perception that previously employed radiation diaphragms are particularly unsuited for those used in a computed tomography apparatus wherein the X-radiator and/or the detector for detecting the X-radiation are rotatable along a gantry with especially high rotational velocity. The radiation diaphragm of the invention is distinguished by an especially simple and rugged design that requires only a very small number of moving parts. It is therefore only slightly susceptible to external influences or movements. In particular, rotational velocities from 3 rps (revolutions per second) up to 5 rps and more are possible in a computed tomography apparatus. It suffices in the limit case when the absorber element and, possibly, a shaft driving it, is movable.

In known radiation diaphragms, the rotary motion generated by a motor must be converted into a linear motion of an absorber element that produces the actual variation of the ray beam. Various mechanical components are required for this purpose. Compared thereto, the rotary motion of a motor in the radiation diaphragm of the invention can be directly converted into a rotary motion of the absorber element so the ray beam can be varied without requiring a linearization of the motion. A simple structure that operates satisfactorily with few component parts thus is achieved.

Any component that is suitable for limiting the ray beam by absorbing parts of the ray beam that are not needed is referred to as absorber element in conjunction with the invention. The absorber element particularly has an outside contour, for example a cylindrical surface, serving the purpose of blanking out parts of the X-rays that are emitted by an X-ray tube but that are not needed for the diagnosis. In other words: rays that can pass the contour of the absorber element are gated into the patient.

According to a preferred embodiment, the absorber element is fashioned as an elongated, rotationally symmetrical body, particularly as a drum, a roller or a cylinder. This has the advantage of a simple and economical manufacture. However, other shapes are also possible for the absorber element that can be realized, for example, by applying or forming or attaching an eccentric element to a rotatable body.

In accordance with the invention the absorber element fashioned as a rotary body can be fabricated to achieve an adequate X-ray absorption. The absorber element preferably contains a material that absorbs X-rays, particularly a material having an attenuation coefficient of more than 1 cm−1, and/or a material having an atomic number of more than 50 or 80, particularly lead or tantalum or tungsten.

In a preferred development of the radiation diaphragm, a further absorber element is provided that—like the aforementioned absorber element—is preferably fashioned as an elongated, rotationally symmetrical body. The further absorber element can be seated or fabricated like the aforementioned absorber element. With two absorber elements, it is possible to vary the size of the ray beam without varying the position of the central ray. It is advantageous for this purpose if the two absorber elements are rotatable by the same rotational angle, either in the same direction or in opposite directions (symmetrical reduction or enlargement of the ray beam, symmetrical gating). To this end, it is also advantageous for the two absorber elements to have their rotational axes aligned parallel to one another.

For a simple design, the two absorber elements have their rotational axes aligned essentially perpendicular to the course of the ray beam.

The two absorber elements preferably are motor-rotatable independently of one another. Separate motors can be present for this purpose. As a result, a symmetrical gating as well as a variation of the position of the middle of the ray beam can be realized, particularly given rotation of the absorber elements by different rotational angles.

The motor or motors for turning the absorber element or elements are, in particular, stepping motors.

The above object also is achieved in accordance with the invention in an X-ray apparatus is inventively achieved by an X-ray apparatus, particularly a computed tomography apparatus, having a radiation diaphragm as described above.

### DESCRIPTION OF THE DRAWINGS

FIG. 1 shows an X-ray apparatus of the invention in a schematic overall view.

FIG. 2 shows a radiation diaphragm of the X-ray apparatus of FIG. 1 in a direction as seen proceeding from a gated X-ray beam.

FIG. 3 is a section through the radiation diaphragm of FIG. 2.

FIG. 4 is a longitudinal side view of the radiation diaphragm of FIGS. 2 and 3.

FIG. 5 shows the radiation diaphragm of FIGS. 2 through 4 enlarged and in closed position.

FIG. 6 shows the radiation diaphragm of FIGS. 2 through 4 enlarged and illustration in a maximally open position.

### DESCRIPTION OF THE PREFERRED EMBODIMENTS

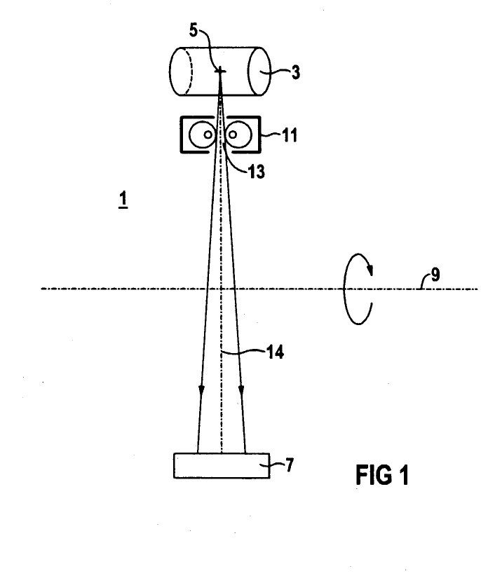

FIG. 1 shows an X-ray apparatus 1 fashioned as a computed tomography apparatus, only the rotating part thereof with an X-ray radiator 3, that has a focus 5, and a detector 7 being shown. The X-ray radiator 3 and the detector 7 rotate around an axis 9. A radiation diaphragm 11 fashioned as a primary radiation diaphragm generates a fan-shaped X-ray beam 13 that transirradiates a patient (not shown) through which the axis 9 passes. A central ray of the X-ray beam 13 is referenced 14.

Together with the X-ray radiator 3 and the detector 7, the radiation diaphragm 11 rotates around the axis 9. A gantry that is present for the mechanical realization of the rotary motion is not explicitly shown for reasons of clarity. Upon rotation of the components 3, 7, 11, the patient is transirradiated from various directions, and a computer calculates an image of the transirradiated part of the patient from the output signals of the detector 7. The fan plane proceeds perpendicularly to the plane of the drawing, and the detector 7 is composed of a row of individual detectors that likewise extends perpendicular to the plane of the drawing. To this end, the detector 7 is also curved around the focus 5.

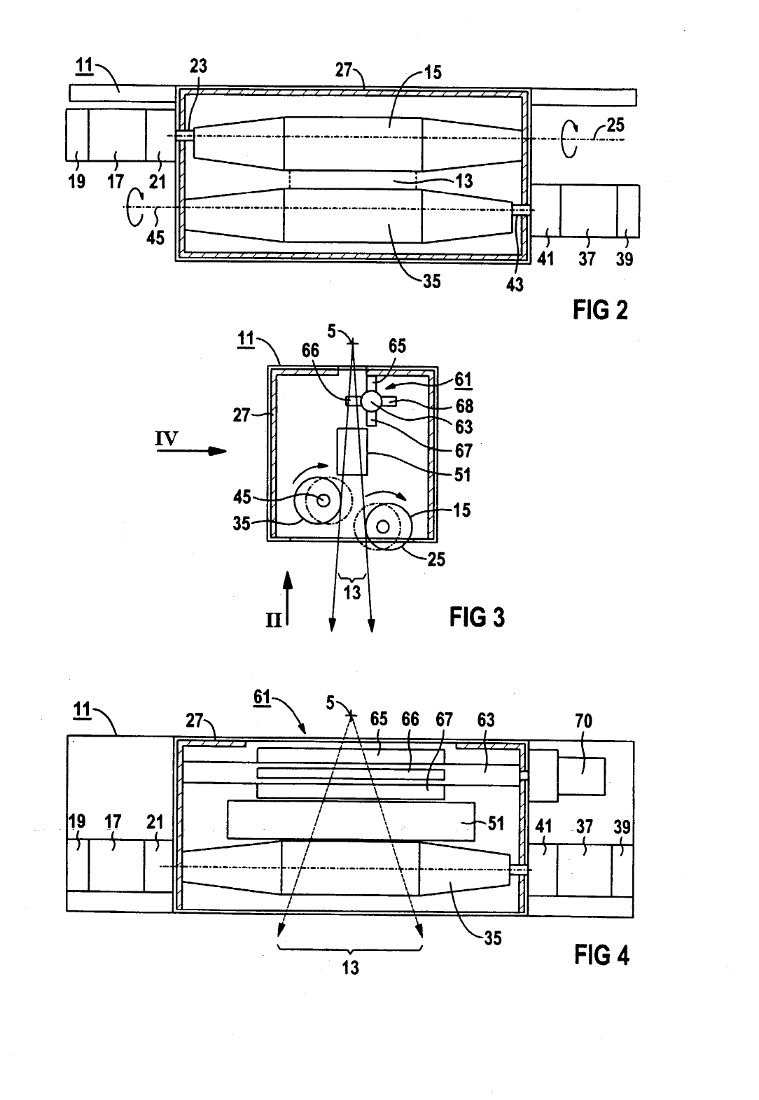

The radiation diaphragm 11 is shown simplified in FIG. 1 and is explained in greater detail below on the basis of FIGS. 2 through 4.

According to FIG. 2, the radiation diaphragm 11 has an oblong absorber element 15 that is fabricated of lead or a lead alloy either entirely or partly or in sections. The absorber element 15 is fashioned as a rotationally symmetrical body having a cylindrical middle region and end regions that conically taper toward respective bearing ends. The middle region and the two end regions are fabricated of one piece. For the automatic drive with a rotary motion of the absorber element 15, a stepping motor 17 having an encoder 19 and a transmission 21 is allocated thereto. Via the transmission 21, the stepping motor 17 drives a shaft 23 on which the absorber element 15—which has an inside bore—is slipped and secured. The shaft 23 is fabricated of steel and has an end lying opposite the stepping motor seated at a housing 27 of the radiation diaphragm 11. The shaft 23 proceeds eccentrically through the absorber element 15, so that the absorber element 15 has a rotational axis 25 that is eccentrically seated. All rotational axes, i.e. the rotational axis of the motor 17, rotational axes as may exist in the transmission 21 and the rotational axis 25 of the absorber element 15, are parallel to one another. No linear motion occurs.

A further oblong absorber element 35 also is provided, this being fashioned analogously to the aforementioned absorber element 15, and having a stepping motor 37, an encoder 39, a transmission 41 and a shaft 43 allocated to it in an analogous fashion. The further absorber element 35 also has a rotational axis 45 that is eccentrically seated.

The two rotational axes 25, 45 of the absorber elements 15, 35 proceed parallel to one another and perpendicular to the ray beam 13. The slit-like region enclosed by the middle regions of the two absorber elements 15, 35 defines that region of the ray beam 13 that is gated into the patient.

The rotary motion of the two absorber elements 15, 35 for varying the size of the ray beam 13 is explained in greater detail in the cross-sectional illustration of FIG. 3. A ray beam 13 having a defined slit size is allowed to pass in the position of the absorber elements 15, 35 that is shown with solid lines. The radiation diaphragm 11 is closed in the position of the absorber elements 15, 35 that is shown with broken lines, so that no radiation proceeds to the patient.

A position-variable wedge filter 51 for the variable attenuation of the X-radiation is also integrated into the housing 27 of the radiation diaphragm 11. A filter device 61 is also present with which different spectral quantum energy distributions can be impressed on the ray beam 13. For this purpose, four spectral filters 65, 66, 67, 68 that are different from one another are attached on a rotatable carrier 63 at equidistant angular spacings. A desired spectral filter 65, 66, 67, 68 can be positioned in the beam path with a motor 70 (see FIG. 4).

It is self-evident that the focus side of the housing 27 has an aperture for the admission of the X-radiation deriving from the X-radiator 3 and comprises an exit aperture at the opposite side.

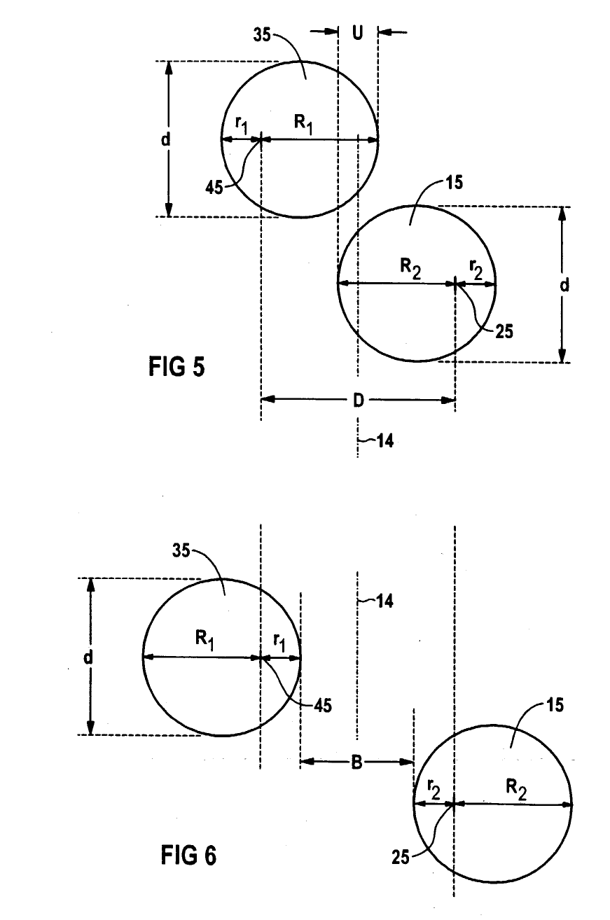

As already indicated in FIG. 3, it is advantageous if the two absorber elements 15, 35 are arranged slightly behind one another or offset as viewed in the direction of the ray beam 13. As explained in greater detail in FIGS. 5 and 6, namely, the advantage derives therefrom that the radiation diaphragm 11 can completely block the ray beam 13 in the position shown in FIG. 5. As a result of the attachment of the absorber element 15, 35 behind one another—as seen in the direction of the central ray 14 --, the radiation diaphragm 11 can close with a lateral overlap U of the absorber elements 15, 35. Given an exact side-by-side arrangement of the two absorber elements 15, 35, and at essentially the same distance from the focus 3, the absorber elements 15, 35 would at most touch in one point in the closed condition, resulting in an inadequate absorption in this region. Due to manufacturing imprecision and for a dependable operation, a small gap would even have to remain between the absorber elements in the closed condition. Compared thereto, the illustrated overlap U (=R1+R2—D) in the closed condition of the radiation diaphragm 11 according to FIG. 5 sees to an adequate absorption of the central ray 14 as well.

FIG. 6 shows the arrangement as in FIG. 5, wherein the two absorber elements 15, 35 each have been rotated by 180° around their respective rotational axes 25 and 45 compared to the position in FIG. 5. As a result, the major radii R₁, R₂ of the middle regions of the absorber elements 15, 35 now face away from the central ray 14, and only the minor radii r1, r2 face toward the ray beam (d=R₁+r₁=R₂+r₂). A maximum diaphragm aperture B is possible in the condition shown in FIG. 6.

For a prescribed, desired overlap and a prescribed, maximum diaphragm aperture B (=D−r1−r2), the required rotational axis spacing D between the rotational axes 25 and 45 of the absorber elements 15, 35 is established by

$$D = d + \frac{B - U}{2}$$

given a prescribed diameter d of the middle regions of the absorber elements 15, 35.

Although modifications and changes may be suggested by those skilled in the art, it is the intention of the inventor to embody within the patent warranted hereon all changes and modifications as reasonably and properly come within the scope of his contribution to the art.

I claim as my invention:

1. A radiation diaphragm comprising:
an absorber element composed of a material which absorbs radiation, said absorber element having a cross section with a center and a longitudinal axis proceeding perpendicularly through said cross section spaced from said center; and
a mount in which said absorber element is mounted for eccentric rotation around said longitudinal axis so that as said absorber element is rotated, a variable portion of said absorber element is located within a path of a beam of said radiation.

2. A radiation diaphragm as claimed in claim 1 wherein said absorber element is an elongated body which is rotationally symmetrical relative to said center.

3. A radiation diaphragm as claimed in claim 1 wherein said body is selected from the group consisting of drums, rollers and cylinders.

4. A radiation diaphragm as claimed in claim 1 wherein said absorber element contains X-ray absorbing material.

5. A radiation diaphragm as claimed in claim 4 wherein said X-ray absorbing material is selected from the group consisting of lead, tantalum and tungsten.

6. A radiation diaphragm as claimed in claim 1 wherein said absorber element is a first absorber element and wherein said longitudinal axis is a first longitudinal axis, and wherein said radiation diaphragm further comprises a second absorber element having a cross section with a center, said second absorber element being mounted in said mount for eccentric rotation around a longitudinal axis proceeding perpendicularly through said cross section of said second absorber element and being spaced from said center of said cross section of said second absorber element, so that a variable portion of said second absorber element is disposed in said beam as said second absorber element rotates.

7. A radiation diaphragm as claimed in claim 6 wherein said first and second longitudinal axes are parallel to each other.

8. A radiation diaphragm as claimed in claim 6 wherein said beam has a propagation path and wherein said first and second longitudinal axes are disposed perpendicular to said propagation path.

9. A radiation diaphragm as claimed in claim 6 further comprising first and second motors for respectively rotating said first and second absorber elements independently of each other.

10. A radiation diaphragm as claimed in claim 9 wherein said first and second motors are stepping motors.

11. A radiation diaphragm as claimed in claim 1 further comprising a stepping motor from rotating said absorber element in said mount.

12. An X-ray apparatus comprising:
an X-ray source which emits an X-ray beam; and
a radiation diaphragm comprising an absorber element composed of a material which absorbs radiation in said X-ray beam, said absorber element having a cross section with a center and a longitudinal axis proceeding perpendicularly through said cross section spaced from said center, and a mount in which said absorber element is mounted for eccentric rotation around said longitudinal axis so that as said absorber element is rotated, a variable portion of said absorber element is located within a path of a beam of said X-ray beam.

13. An X-ray apparatus as claimed in claim 12 wherein said absorber element is an elongated body which is rotationally symmetrical relative to said center.

14. An X-ray apparatus as claimed in claim 12 wherein said body is selected from the group consisting of drums, rollers and cylinders.

15. An X-ray apparatus as claimed in claim 12 wherein said absorber element contains X-ray absorbing material selected from the group consisting of lead, tantalum and tungsten.

16. An X-ray apparatus as claimed in claim 12 wherein said absorber element is a first absorber element and wherein said longitudinal axis is a first longitudinal axis, and wherein said radiation diaphragm further comprises a second absorber element having a cross section with a center, said second absorber element being mounted in said mount for eccentric rotation around a longitudinal axis proceeding perpendicularly through said cross section of said second absorber element and being spaced from said center of said cross section of said second absorber element, so that a variable portion of said second absorber element is disposed in said beam as said second absorber element rotates.

17. An X-ray apparatus as claimed in claim 16 wherein said first and second longitudinal axes are parallel to each other.

18. An X-ray apparatus as claimed in claim 16 wherein said beam has a propagation path and wherein said first and second longitudinal axes are disposed perpendicular to said propagation path.

19. An X-ray apparatus as claimed in claim 16 further comprising first and second motors for respectively rotating said first and second absorber elements independently of each other.

20. An X-ray apparatus as claimed in claim 19 wherein said first and second motors are stepping motors.

21. An X-ray apparatus as claimed in claim 12 further comprising a stepping motor from rotating said absorber element in said mount.
